(19) United States
(12) Patent Application Publication
(10) Pub. No.: US 2015/0179086 A1
(43) Pub. Date: Jun. 25, 2015

(54) UTENSIL COMPRISING SENSOR

(71) Applicants: HONG SOON KIM, Lynbrook, NY (US); Jin Ok Choi, Lynbrook, NY (US)

(72) Inventors: HONG SOON KIM, Lynbrook, NY (US); Jin Ok Choi, Lynbrook, NY (US)

(21) Appl. No.: 14/543,741

(22) Filed: Nov. 17, 2014

(30) Foreign Application Priority Data
Dec. 24, 2013 (KR) 10-2013-0162360
Jan. 15, 2014 (KR) 10-2014-0004872

(51) Int. Cl. G09B 19/24; A47G 21/02; A47G 21/04

(52) U.S. Cl. CPC G09B 19/24; A47G 21/04; A47G 21/023

(57) ABSTRACT

In an embodiment, an utensil may include a first head having a concave shape and configured to contain food, a handle coupled to the first head and configured to act as a handle for the first head, a first sensor in the handle and configured to detect a user's body part, a second sensor in the first head and configured to sense the food or the user's body part, a control circuit in the handle and configured to determine whether the food contained in the first head is eaten by the user according to change in sensing signals received from the first sensor and the second sensor, and an output device in the handle and configured to output sound or light, or both, according to a result of the determination made by the control circuit.

### CROSS-REFERENCE TO RELATED APPLICATIONS

The present application claims priority to Korean patent application number 10-2013-0162360, filed on Dec. 24, 2013 and Korean patent application number 10-2014-0004872, filed on Jan. 15, 2014, the entire disclosure of which is incorporated herein in its entirety by reference.

### BACKGROUND

1. Field of Invention

Various exemplary embodiments of the present invention relate to an utensil comprising a sensor.

2. Description of Related Art

At the time of weaning babies, or when babies start learning to use utensils such as spoons or forks, they may not eat food using the utensils in a proper manner or find using the utensils difficult and lose interest in using the utensils to eat food. Also, children at daycare centers, kindergartens, and the like, may have similar problems when it comes to eating using utensils. Therefore, it may be difficult to have babies or children develop healthy and proper eating habits.

### SUMMARY

In an embodiment, an utensil may include a first head having a concave shape and configured to contain food, a handle coupled to the first head and configured to act as a handle for the first head, a first sensor provided in the handle and configured to detect a user's body part, a second sensor provided in the first head and configured to sense the food or the user's body part, a control circuit provided in the handle and configured to determine whether the food contained in the first head is eaten by the user according to change in sensing signals received from the first sensor and the second sensor, and an output device provided in the handle and configured to output sound or light, or both, according to a result of the determination made by the control circuit.

In an embodiment, an utensil may include a head having tines for spearing food, a handle coupled to the head and configured to act as a handle for the head, a first sensor provided in the handle and configured to sense a user's body part; a second sensor provided in the head and configured to sense the food or the user's body part, a control circuit provided in the handle and configured to determine whether the food is stuck on or speared by the head and whether the user has consumed food stuck on or speared by the head by sensing change in a signal received from the first sensor and second sensors, and an output device provided in the handle and configured to output light or sound, or both, according to a result of the determination made by the control circuit that the user has consumed the food.

### BRIEF DESCRIPTION OF THE DRAWINGS

The above and other features and advantages of the present invention may become more apparent to those of ordinary skill in the art by describing in detail exemplary embodiments with reference to the attached drawings in which:

FIG. 1 is a diagram illustrating an utensil according to an embodiment.

FIG. 2 is a diagram distinguishing states sensed by sensors.

FIG. 3 is a flowchart describing a process for sensing by sensors.

FIG. 4 is a diagram describing an utensil according to another embodiment.

### DETAILED DESCRIPTION

Exemplary embodiments will provide an utensil to help young children to consume food voluntarily by drawing children's interest through either, when the children consume food by a fork or spoon, lighting a popular character printed on a body of the disclosed invention, or provides the popular character's voice of compliments.

Various exemplary embodiments of the present invention may be described. In the drawings, elements and regions are not drawn to scale, and their sizes and thicknesses may be exaggerated for clarity. In the description of the present invention, known configurations that are not central to the principles of the present invention may be omitted. Throughout the drawings and corresponding description, the same components are denoted by the same reference numerals.

While the spirit and scope of the invention describe in detail exemplary embodiments of the invention, it should be noted that the above-described embodiments are merely descriptive and should not be considered as limiting. Further, it should be understood by those skilled in the art that various changes, substitutions, and alterations may be made herein without departing from the scope of the invention as defined by the following claims.

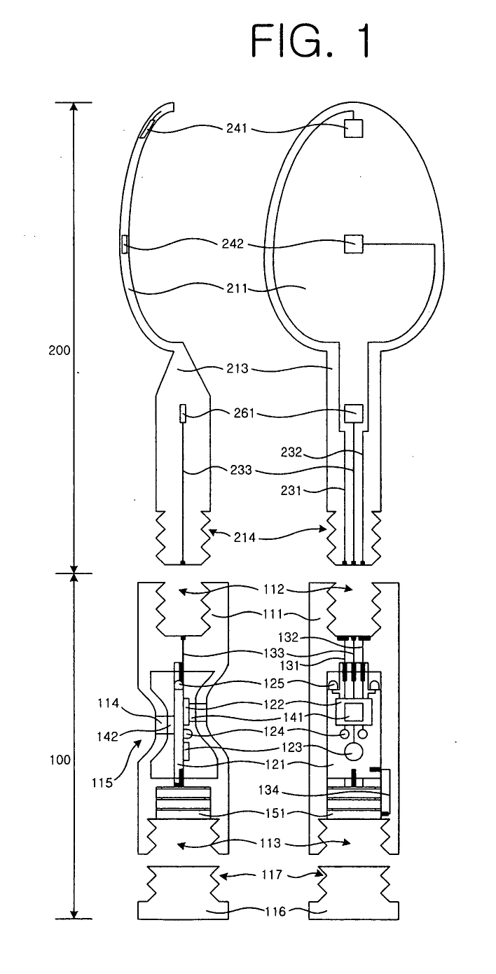

Hereinafter, proper exemplary embodiments of the disclosed invention may be described with reference to the accompanying drawings. FIG. 1 is a diagram illustrating an utensil according to an embodiment.

According to FIG. 1, an utensil may include a handle 100 and a head 200. A first sensor 141 and 142, a control circuit 122, an output device 123, 124 and 125 are may be provided in a body 111 of the handle 100. The first sensor may include a first sensing unit 141 and a second sensing unit 142. Second sensor 241 and 242 may be provided in the head 200. The second sensor may include a third sensing unit 241 and a fourth sensing unit 242. The handle 100 and the head 200 may be manufactured as one single body or manufactured to be separable. Description is provided below.

The handle 100 may include control device 121 and 122, the first sensor 141 and 142 and output device 123, 124 and 125 at the body 111 and inside the body 111, and the remaining space of the body 111 may be filled with insulating material (not shown). The control device 121 and 122, the first sensor 141 and 142, and the output device 123, 124 and 125 may be isolated from oxygen or moisture by the insulating material. A battery 151 for supplying power to the control device 121 and 122, the first sensor 141 and 142, and the output device 124, 125 and 123 may be provided in the body 111. The battery 151 may supply power to the control device 121 and 122 through a wire 134.

Stud female threads 112 and 117 may be formed at each end of the body 111. An end of the body 111 where the battery 151 may be provided may be sealed by a cover 116 where a stud male thread 117 is formed. The body 111 may be formed of insulating material (e.g., material forming baby bottles or silicon) that is transparent so as to transmit light. Popular characters may be printed on a surface of the body 111.

The control device may include a circuit board 121 and the control circuit 122 provided on the circuit board 121. The output device 124, 125 and 123 may be provided at the circuit board 121. Additional wires 131, 132 and 133 may be provided at the body 111. The additional wires 131, 132 and 133 may electronically couple the control device 121 and 122 provided in the body 111 to the second sensor 241 and 242 and an identification device 261 of the head 200.

The output device may include a speaker 123 and light emitting diodes (LEDs) 124 and 125. The speaker 123 may output sound (e.g., character's voice) according to control by the control circuit 122.

The LED 124 may output light having a pattern set according to the control of the control circuit 122. The LED 125 may be provided on a side of the circuit board 121 facing towards the head 200 and may output light to the outside having the pattern set by the control of the control circuit 122. All or some of the LEDs 123 and 124 may be provided on the circuit board 121. According to the control of the control circuit 122, the output device 124, 125 and 123 may transmit light or output character's voice, or both.

The first sensor 141 and 142 may be provided at the circuit board 121 in the body 111 and may be configured to sense objects (e.g., a hand) approaching the handle 100. The first sensor 141 and 142 may sense objects through a transparent window 114 of the body 111. The first sensor may include, all or one of, the first sensing unit 141 configured to sense objects approaching an upper surface of the handle 100 and the second sensing unit 142 configured to sense objects approaching a bottom surface of the handle 100. The first sensing unit 141 may be provided on an upper side of the circuit board 121. The second sensing unit 142 may be provided on the bottom surface of the circuit board 121.

A groove 115 may be formed to make the body 121 thin from where the first sensor 141 and 142 is provided. The groove 115 may be formed where the hand or fingers touch the handle when the user grabs the handle in a proper manner. Since the groove 115 is formed, children may grab the handle in a proper manner by placing their hands or fingers on the groove 115. Furthermore, since the groove 115 is formed, the distance between the first sensor 141 and 142 and the body of the user may be shortened, and sensing characteristics or features of the first sensor 141 and 142 may be improved.

The head 200 may be recognized as being divided into a head portion 211 having a concave shape for containing food, and a connecting portion 213 coupled to the handle 100. The head 200 may be formed of insulating material (e.g., material forming baby bottles or silicon) that is transparent to transmit light, and popular characters may be printed on the concave head portion 211 where food may be contained.

In the head 200, the second sensor 241 and 242 and the identification device 261 may be provided. The wires 231, 232 and 233 may be further provided. The wires 231, 232 and 233 may electronically couple the second sensor 241 and 242 and the identification device 261 to the control circuit 122. In the head 200, the second sensor 241 and 242, the identification device 261, and the wires 231, 232 and 233 may be water-proofed to be protected from air or moisture from the outside. Stud male threads 214 may be formed at an end of the connecting portion 213 of the head 200 and may be coupled to the stud female threads 112 of the handle 100. When the head 200 is coupled to the handle 100, the wires 231, 232 and 233 of the head 200 may be coupled to the wires 131, 132 and 133 of the handle 100.

The second sensor may include the third sensing unit 241 provided either at an end of at the head 200 or at an end of the head portion 211 and the fourth sensing unit 242 provided either at a center of at the head 200 or at a center of the head portion 211. The third sensing unit 241 may sense food or user's body parts (e.g., a tongue) approaching a lower surface of the head 200 from either the end of the head 200 or the end of the head portion 211. The fourth sensing unit 242 may sense food or user's body parts (e.g., the tongue) approaching an upper surface of the head 200 from either the center of the head 200 or the center of the head portion 211.

The third sensing unit 241 may be provided at the center of the head 200 or the head portion 211 where it is concave near the fourth sensing unit 242. Here, the third sensing unit 241 may sense food or user's body parts approaching the lower surface of the head 200 from either the center of the head 200 or the center of the head portion 211. The fourth sensing unit 242 may sense food or user's body parts approaching the upper surface of the head 200 from either the center of the head 200 or the center of the head portion 211.

The first sensor 141 and 142 and the second sensor 241 and 242 may include either any one of, or two or more of an illuminance sensor, a proximity sensor, a heat sensor, a touch sensor and a switch.

For instance, the first sensor 141 and 142 and the second sensor 241 and 242 may all be composed with the proximity sensor. Furthermore, the first sensor 141 and 142 may be the illuminance sensors or the heat sensors, and the second sensor 241 and 242 may be composed of the proximity sensors. In a case when the first sensor 141 and 142 or the second sensor 241 and 242 are composed of the illuminance sensors, determination error of the control circuit 122 may occur as the illuminance sensors sense the light generated from the LEDs 124 and 125. Accordingly, the control circuit 122 may be configured to ignore signals received from the sensors 141, 142, 241 and 242 during when the output devices 123, 124 and 125 operate.

A conductive window may be provided instead of the transparent window 114 of the body 111. The first sensor 141 and 142 may be composed with the touch sensors operated by fluctuating current when a body part comes into contact with the conductive window. Furthermore, the window 114 of the body 111 may be formed of soft material, and the first sensor 141 and 142 may be composed with touch sensors or switches. When the user grabs the handle 100, fingers may be placed on the groove 115 and may push the switch composing the first sensor 141 and 142 through the soft window 114. The control circuit 122 may control operations of the output device 123, 124 and 125 in accordance with operations of the touch sensor or the switch. Not only the first sensor 141 and 142, but also the second sensor 241 and 242 may include touch sensors or the switches.

The location, number, type, and the like, of the sensors 141, 142, 241 and 242 described above may be changed as needed to increase sensing accuracy.

The identification device 261 may be provided in the head 200 to output an identification signal to enable the control circuit 122 to check the type of the head 200. In response to the identification signal of the identification device 261, the control circuit 122 may control the output device 123, 124 and 125 to output light or sound appropriate for the type of the head 200 or to output both the light and the sound. For instance, the output device 123, 124 and 125 may output a voice appropriate for the character printed on the head 200 in response to the identification signal of the identification device 261. For this purpose, a number of character's voices may be stored in the control circuit 122. The control circuit 122 may determine whether the head 200 is a part of a fork or a spoon depending on the identification signal of the identification device 261 and may change a controlling method of the output device 123, 124 and 125 in accordance with a result of the determination.

The control circuit 122 may be configured to determine a state as to how food is contained in the head 200 or determine whether the user has consumed the food contained in the head 200 by sensing change in pattern of the sensing signals received from the first and second sensors 141, 142, 241 and 242. The output device 123, 124 and 125 may operate only when the control circuit 122 determines that the user has consumed the food contained in the head 200, or, the output device 123, 124 and 125 may operate when the control circuit 122 determines that the food is contained in the head 200 and that the user has consumed the food contained in the head 200.

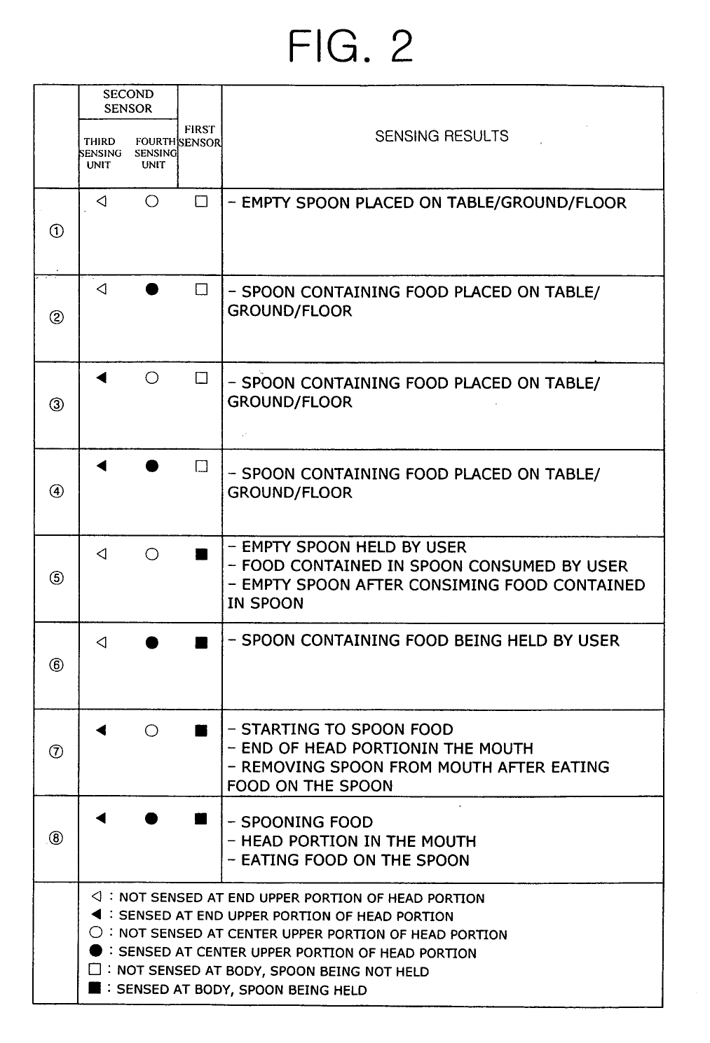

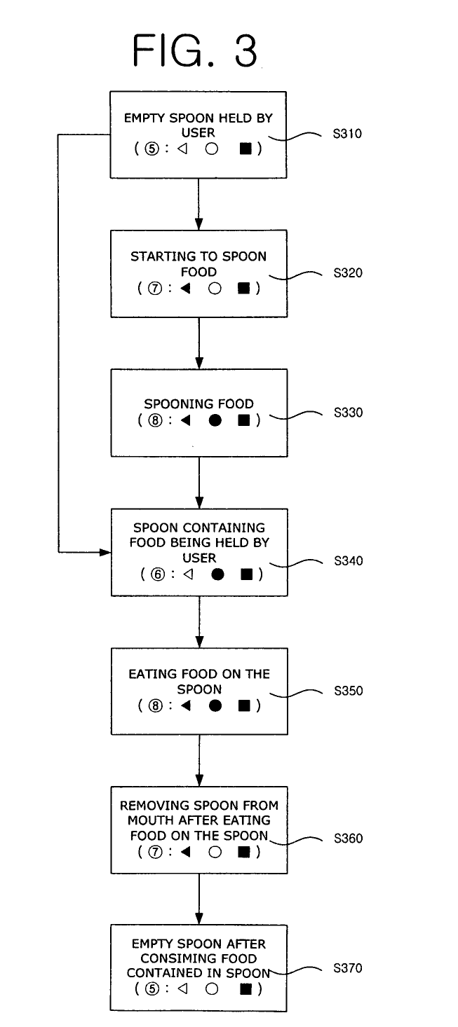

Hereinafter, an operating method of the utensil will be described with the assumption that the first sensor includes only one of the first and second sensing units 141 and 142, and the second sensor includes all of the third and fourth sensing units 241 and 242. FIG. 2 is a diagram distinguishing states sensed by sensors. FIG. 3 is a flow chart describing a process for sensing by sensors.

Referring to FIG. 2, current states which may be defined in accordance with sensing results from one sensing unit included in the first sensor and two sensing units included in the second sensor of the handle, are listed. When there are three sensing units, there may be eight (8) sensing results, and one sensing result may be defined by two or more different states.

For example, a first to fourth sensing results may be obtained when no object (food or user's body part) is sensed by the first sensor. That is, the first to fourth sensing results may be obtained in a state in which no object approaching the handle (or body) of the utensil is sensed. In accordance with the sensing results of the first and second sensors, the control circuit may determine the state as a state in which a spoon is placed on a table (or the ground or floor). Depending on the sensing result from the second sensor, however, it may be determined whether an empty spoon is placed on the table or a spoon with food contained therein is placed on the table. However, since all of the first to fourth sensing results are determined as though the spoon is placed on the table and that no food is contained or consumed, the output devices may not operate.

Meanwhile, the first to fourth sensing results may be obtained even when the first sensor does not sense the user's body because the user is holding the spoon in a wrong way. In this case, it is preferable that the output device does not operate such that the user may learn how to use a spoon properly. Accordingly, it is preferable that the output device does not operate even when the user was successful in consuming food using the spoon when the first to fourth sensing results are obtained.

Fifth to eighth sensing results may be obtained when an object (food or user's body part such as a finger) is sensed by the first sensor. Accordingly, the control circuit may determine that the user is holding the spoon in a right way from the fifth to eighth sensing results, and operation states may be classified in detail according to the sensing results from the second sensor. This is described below.

The fifth sensing result may be obtained when an object is sensed by the first sensor and no object is sensed by the second sensor. That is, the fifth sensing result may be obtained when an object (e.g., user's body part) is sensed at the handle or the body and when no object (e.g., food or user's body part) is sensed at the center of the head or the end of the head. The control circuit may determine that the user is holding an empty spoon depending on the fifth sensing result, or that the user has consumed the food contained in the spoon according to the changing patterns of the sensing results.

The sixth sensing result may be obtained when an object is sensed by the first sensor and when an object is sensed by the fourth sensing unit of the second sensor to be at the center of the head only. That is, the sixth sensing result may be obtained when an object (e.g., user's body part) is sensed at the handle or the body, an object (e.g., food) is sensed at the center of the head and no object (e.g., food or user's body part such as a tongue) is sensed at the end of the head. Depending on the sixth sensing result, the control circuit may determine that the user is holding a spoon containing food.

The seventh sensing result may be obtained when an object is sensed by the first sensor and when an object is sensed by the third sensing unit of the second sensor to be at the end of the head. That is, the seventh sensing result may be obtained when an object (e.g., user's body part) is sensed at the handle or the body, no object (e.g., food) is sensed at the center of the head and an object (e.g., food or user's body part) is sensed at the end of the head. Depending on the seventh sensing result, the control circuit may determine that the user is starting to put food on the spoon, that the end of the head is inside the user's mouth, or that the user is removing the spoon from his or her mouth after consuming the food.

The eighth sensing result may be obtained when an object is sensed by the first sensor and when an object is sensed by the third and fourth sensing units of the second sensor to be at the end and the center of the head. That is, the seventh sensing result may be obtained when an object (e.g., user's body part) is sensed at the handle or the body and when an object (e.g., food or user's body part) is sensed both at the center and the end of the head. Depending on the eighth sensing result, the control circuit may determine that the user is putting food onto the spoon, that the end and the center (which is concave) of the head are in the user's mouth or that the user is consuming the food.

As described above, the control circuit may determine current states depending on the sensing results. Particularly, the control circuit may analyze change in pattern by using sensing signals input from the sensors and sensing signals input previously and may determine the current state based on the analysis result, thereby determining the current states more accurately. That is, the control circuit, by using the sensing signals input from the sensors and the sensing signals input previously, may choose the most fitting state out of the several states as determined based on the sensing results. This is described in detail below.

Referring to FIGS. 2 and 3, a process for consuming food may take five steps (S310 and S340 to S370) or seven steps (S310 to S370). It may be preferable to control the output device to output light and sound (e.g., character's voice in giving a compliment) only when the control circuit determines that the five steps (S310, S340˜S370) or the seven steps (S310˜S370) have been performed in order in accordance with change in pattern of the sensing signals.

The first step (S310) may refer to a state in which the fifth sensing result is obtained by the sensors, and the control circuit may determine the state as a state in which the user is holding an empty spoon. Particularly, when the first sensing result is converted into the fifth sensing result after the first sensing result has been obtained, the control circuit may determine the state as a state in which the user is holding an empty spoon to consume food.

The second step (S320) may refer to a state where the seventh sensing result is obtained from the sensors after the fifth sensing result has been obtained. The control circuit may determine the state as a state where the user has started spooning food. That is, when the fifth sensing result is converted into the seventh sensing result, an object is starting to be sensed at the end of the head. The control circuit may determine the state as a state where the user has started spooning food to consume it.

The third step (S330) may refer to a state where the eighth sensing result is obtained from the sensors after the seventh sensing result is obtained. The control circuit may determine the state as a state in which the user is spooning food. That is, when the seventh sensing result is converted into the eighth sensing result, an object is beginning to be sensed at the concave center of the head. The control circuit may determine the state as a state where the user is spooning food to consume it.

The fourth step (S340) may refer to a state where the sixth sensing result is obtained by the sensors after the eighth sensing result is obtained. The control circuit may determine the state as a state where the user is holding the spoon containing food. That is, when the eighth sensing result is converted into the sixth sensing result, an object is sensed only at the concave center of the head, not sensed at the end of the head. The control circuit may determine the state as a state where the user has completed an operation for spooning food to consuming it.

The fifth, seventh, and eighth sensing results may be sequentially obtained even when the user puts an empty spoon into his or her mouth as is the case in the first to third steps (S310 to S340). However, as soon as the user removes the empty spoon out of his or her mouth, the fifth sensing result of the first step (S310) may be obtained instead of the sixth sensing result of the fourth step (S340). Accordingly, the process of spooning food may be distinguished from the process of putting a spoon into and removing the spoon from the mouth.

Meanwhile, when someone other than the user puts food on the spoon held by the user, the fourth step (S340) may be performed immediately after the first step (S310). That is, the control circuit may determine the state as a state where the user is holding the spoon containing food even when the fifth sensing result is converted into the sixth sensing result.

When it has come to the fourth step after the above steps are processed, depending on the control of the control circuit, the output device may output a voice of a character recommending the user to eat food and light in order to encourage the user holding the spoon to consume food.

The fifth step (S350) may refer to a state where the eighth sensing result is obtained after the sixth sensing result is obtained. The control circuit may determine the state as a state where the user is consuming food contained in the spoon. That is, when the sixth sensing result is converted into the eighth sensing result, the control circuit may determine the state as a state where the user has put the spoon containing food into the user's mouth because an object (e.g., the user's tongue) is newly sensed at the end of the head while the object is being sensed at the concave center of the head.

The sixth step (S360) may refer to a state where the seventh sensing result is obtained after the eighth sensing result is obtained. The control circuit may determine the state as a state where the user is removing the spoon from the mouth after having consumed the food. That is, when the eighth sensing result is converted into the seventh sensing result, the object which was sensed at the concave center of the head disappears and an object (e.g., the user's tongue) is continuing to be sensed only at the end of the head. The control circuit may determine the state as a state where the user is removing the spoon from the mouth after having consumed the food.

The seventh step (S370) may refer to a state where the fifth sensing result is obtained after the seventh sensing result is obtained. The control circuit may determine the state as a state where the user has completed removed the spoon from his or her mouth after having consumed the food contained in the spoon. That is, when the seventh sensing result is converted into the fifth sensing result, the object (e.g., user's tongue) sensed at the end of the head has disappeared and an object (e.g., the user's body part) is continuing to be sensed at the handle of the spoon. The control circuit may determine the state as a state where the user has completed the operation of eating the food contained in the spoon.

When it has come to the seventh step through the steps described above, the output device may output light and character's complimenting voice in accordance with the control of the control circuit to compliment the user who has consumed the food.

Thus, the control device may be configured to clearly determine the current state by clearly distinguishing each state depending on an input sequence (i.e., change in pattern), an input interval, input timing, and the like of the sensing signals input from the sensors and checking continuity of several states. As a result, the control device may control the output device to output light or sound, or both, only after food is placed in the head or consumed.

As described above, an utensil may be provided which outputs light and sound when food is put on the spoon to encourage the user to eat the food, and which outputs light and sound of complimenting consumption of food after the food is eaten by the user, thereby allowing children to develop the right habit of voluntarily and enjoyably eating food.

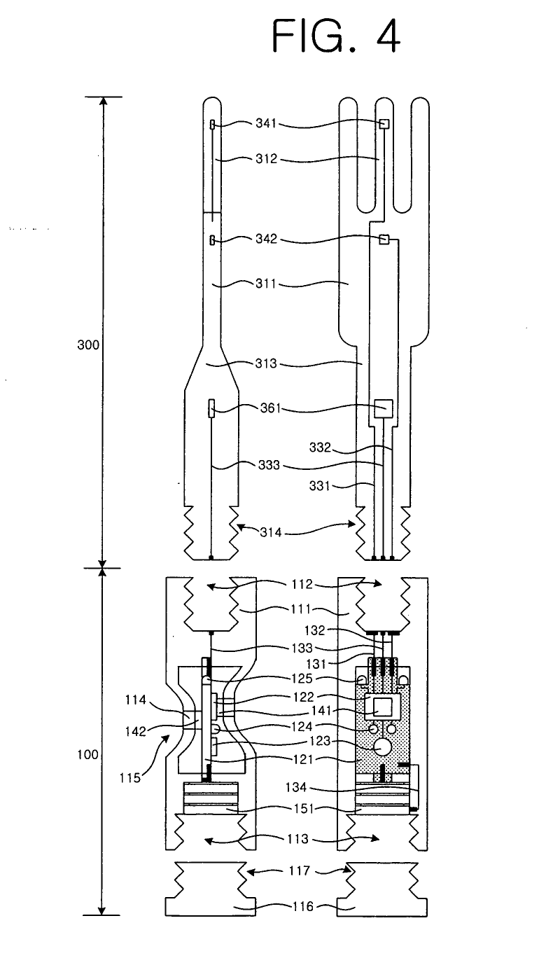

Hereinafter, an embodiment in which an utensil is a fork is described. FIG. 4 is a drawing describing an utensil of another embodiment.

Referring to FIG. 4, the utensil may include a handle 100 and a head 300. The handle 100 may be identical to the handle 100 shown in FIG. 1. Accordingly, description regarding the handle 100 is omitted.

The head 300 may include a head portion 311 having several sharp tines 312 for spearing food, and a connecting portion 313 coupled to the handle 100. The head 300 may be composed of transparent insulating material (e.g., material forming baby bottles or silicon) capable of transmitting light. Popular characters may be printed on the head portion 311.

Third sensor 341 and 342 and an identification device 361 may be provided in the head 300. Wires 331, 332 and 333, configured to electrically coupling the third sensor 341 and 342 and the identification device 361 to a control circuit 122 of the handle 100 may be further provided. In the head 300, the third sensor 341 and 342, the identification device 361, and the wires 331, 332 and 333 may be water-proofed to be protected from air or moisture from the outside. Stud male threads 314 may be formed at an end of the connecting portion 313 of the head 300. The stud male threads 314 may be coupled to stud female threads 112 of the handle 100. When the head 300 is coupled to the handle 100, the wires 331, 332 and 333 of the head 300 may be coupled to the wires 131, 132 and 133 of the handle 100.

The third sensor may include a first sensing unit 341 provided inside a tine 312 and configured to sense food being speared by the tines 312 of the head 300, and a second sensing unit 342 provided inside the center of the head 300 and configured to sense food or user's body part approaching the head 300. The first and second sensing units 341 and 342 may sense an object approaching an upper surface of the head 300. Furthermore, one of the first and second sensing units 341 and 342 may sense an object approaching the upper surface of the head 300, and the other sensing unit may sense an object approaching a lower surface of the head 300.

The third sensor 341 and 342 may include any one of, or two or more of, an illuminance sensor, a proximity sensor and a heat sensor. For instance, the first and second sensing units 341 and 342 may all include the proximity sensor. Furthermore, the first sensing unit 341 may include the illuminance sensor or the proximity sensor, and the second sensing unit 342 may include the proximity sensor or the heat sensor. When the first or second sensing units 341 and 342 include the illuminance sensor, an error in determination by the control circuit 122 may occur as the illuminance sensor senses light generated from an LED 125. Accordingly, the control circuit 122 may be configured to ignore sensing signals received from the sensors 141, 142, 341 and 342 during when the output device 123, 124 and 125 operates.

A location, a type, and a number of the sensors 141, 142, 341 and 342 described above may be properly adjusted to increase sensing accuracy.

The identification device 361 may be provided in the head 200 to output an identification signal to enable the control circuit 122 to check the type of the head 300. In response to the identification signal of the identification device 361, the control circuit 122 may control the output device 123, 124 and 125 to output light or sound, or both, which would be fitting for the type of the head 300. For example, the output device 123, 124 and 125 may output a voice appropriate for the character printed on the head 300 in response to the identification signal of the identification device 361. Several characters' voices may be stored in the control circuit 122. Also, depending on the identification signal of the identification device 361, the control circuit 122 may determine whether the head 300 is a part of a spoon or a fork, and depending on the determination result, the control circuit 122 may change a control method of the output device 123, 124 and 125.

The identification device 261 of the head 200 and the identification device 361 of the head 300 may be omitted if the control circuit 122 is capable of distinguishing the type of the head 200 and the type of the head (300) in accordance with the signals from the sensors 241 and 242 provided in the head 200 and the signals from the sensors 341 and 342 provided in the head 300.

The head 300 and the handle 100 may be separable. Accordingly, the head 100 shown in FIG. 1 may be coupled to the handle 100 of the head 300 shown in FIG. 4 instead of the head 100 shown in FIG. 1 as it is replaced by the handle 100 of the head 300 shown in FIG. 4. That is, the handle 100 may be used for both the fork and spoon.

Referring to the operation method as described in FIG. 3, the control device 122 of the handle 100 may be configured to clearly distinguish each state depending on the input sequence (i.e., change in pattern), the input interval, the input timing, and the like, of the sensing signals input by the sensors 141, 142, 341 and 342, and to determine the current state clearly by checking continuity of several states. As a result, the control device may control the output device to output light or sound, or both, only after food is stuck on the head or food is consumed.

Provided is an utensil which outputs light and sound to encourage the user to eat food when food is stuck on the fork and which outputs sound for complimenting the user and light after the food is consumed by the user, thereby enabling children to eat food on their own and in an enjoyable manner and to develop healthy eating habit.

What is claimed is:

1. An utensil comprising:
a first head having a concave shape and configured to contain food;
a handle coupled to the first head and configured to act as a handle for the first head;
a first sensor provided in the handle and configured to detect a user's body part;
a second sensor provided in the first head and configured to sense the food or the user's body part;
a control circuit provided in the handle and configured to determine whether the food contained in the first head is eaten by the user according to change in sensing signals received from the first sensor and the second sensor; and
an output device provided in the handle and configured to output sound or light, or both, according to a result of the determination made by the control circuit.

2. The utensil of claim 1, wherein the first sensor comprises any one of, or more of, an illuminance sensor, a proximity sensor, a heat sensor, a touch sensor and a switch.

3. The utensil of claim 1, wherein the second sensor comprises any one of, or more of, an illuminance sensor, a proximity sensor, a heat sensor and a touch sensor.

4. The utensil of claim 1, wherein the first sensor comprises any one of, or both:
a first sensing unit configured to sense the user's body part approaching an upper surface of the handle; and
a second sensing unit configured to sense the user's body part approaching a lower surface of the handle.

5. The utensil of claim 1, wherein the second sensor comprises:
a third sensing unit provided at an end of the first head and configured to sense the food or the user's body part; and
a fourth sensing unit provided at a center of the first head and configured to sense the food or the user's body part.

6. The utensil of claim 5, wherein the third sensing unit is configured to sense the food or the user's body part approaching the lower surface of the first head,
wherein the fourth sensing unit is configured to sense the food or the user's body part approaching the upper surface of the first head.

7. The utensil of claim 1, wherein the control circuit is configured to distinguish a state in which food is contained on an upper surface of the first head and a state in which the user consumed the food contained in the first head according to change in the sensing signals received from the first and second sensors.

8. The utensil of claim 7, wherein the output device operates only when the control circuit determines that the user consumed the food contained in the first head, or when the control circuit determines that the food is contained in the first head and when the control circuit determines that the user consumed the food contained in the first head.

9. The utensil of claim 1, wherein the first head and the handle are separable.

10. The utensil of claim 1, further comprising a first identification device provided in the first head and configured to output a signal for checking a type of the first head,
wherein the control circuit is configured to control the output device to output light or sound, or both, appropriate for the type of the first head in response to the signal of the first identification device.

11. The utensil of claim 1, further comprising:
a second head having tines for spearing the food; and
a third sensor provided in the second head and configured to sense the food or the user's body,
wherein the handle coupled to the second head acts as a handle for the second head.

12. The utensil of claim 11, wherein the third sensor comprises:
a fifth sensing unit provided in the tines and configured to sense the food being speared by the second head; and
a sixth sensing unit provided in the center of the second head and configured to sense the food or the user's body part approaching the second head.

13. The utensil of claim 11, wherein the second head further comprises a second identification device configured to output a signal for checking a type of the second head,
wherein the control circuit is configured to control the output device to output the light or the sound, or both, appropriate for the type of the second head in response to the signal of the second identification device.

14. The utensil of claim 11, wherein the output device is configured to release the light to the first head or the second head, and
wherein the first head and the second head are formed of transparent insulating material and transmit light of the output device to outside.

15. An utensil, comprising:
a head having tines for spearing food;
a handle coupled to the head and configured to act as a handle for the head;
a first sensor provided in the handle and configured to sense a user's body part;
a second sensor provided in the head and configured to sense the food or the user's body part;
a control circuit provided in the handle and configured to determine whether the food is stuck on or speared by the head and whether the user has consumed the food stuck on or speared by the head by sensing change in a sensing signal received from the first and second sensors; and
an output device provided in the handle and configured to output light or sound, or both, according to a result of the determination made by the control circuit that the user has consumed the food.

16. The utensil of claim 15, wherein the first sensor comprises, any one of, or both:
a first sensing unit configured to sense the user's body part approaching an upper surface of the handle; and
a second sensing unit configured to sense the user's body part approaching a lower surface of the handle.

17. The utensil of claim 15, wherein the second sensor comprises:
a third sensing unit provided in the tines and configured to sense the food being speared by the head; and
a fourth sensing unit provided in the center of the head and configured to sense the food or the user's body part approaching the head.

18. The utensil of claim 15, wherein the first sensor comprises any one of, or more of, an illuminance sensor, a proximity sensor, a heat sensor, a touch sensor and a switch,
wherein the second sensor comprises any one of, or more of, the illuminance sensor, the proximity sensor, the heat sensor and the touch sensor.

19. The utensil of claim 15, wherein the head further comprises an identification device provided in the head and configured to output a signal for checking the type of the head,
wherein the control circuit is configured to control the output device to output light or sound, or both, appropriate for the type of the head in response to the signal of the identification device.

20. The utensil of claim 15, wherein the head and the handle are separable,
wherein the output device is configured to release light to the head, and
wherein the head are formed of transparent insulating material capable of transmitting light of the output device to outside.
